(19) United States
(12) Patent Application Publication
(10) Pub. No.: US 2016/0172855 A1
(43) Pub. Date: Jun. 16, 2016

(54) CONSTANT POWER SUPPLY FOR A RESISTIVE LOAD

(71) Applicant: SMITHS DETECTION INC., Edgewood, MD (US)

(72) Inventor: Leonard Cardillo, Tarrytown, NY (US)

(21) Appl. No.: 14/903,667

(22) PCT Filed: Jul. 8, 2014
(86) PCT No.: PCT/US2014/045688

§ 371 Date: Jan. 8, 2016

Related U.S. Application Data
(60) Provisional application No. 61/843,737, filed on Jul. 8, 2013.

(51) Int. Cl. H02J 3/12; G05B 15/02

(52) U.S. Cl. CPC H02J 3/12; G05B 15/02

(57) ABSTRACT

Systems and techniques for supplying constant electrical power within component tolerances to a resistively changing load in an electrical circuit are described. A method includes receiving an indication of a characteristic voltage associated with a load in an electrical circuit. The method also includes receiving an indication of a characteristic current associated with the load, where the indication of the characteristic current is received as an indication of a second characteristic voltage. The method further includes determining a power consumption associated with the load based upon the indication of the characteristic voltage and the indication of the characteristic current. The method also includes adjusting at least one of a voltage or a current supplied to the load based upon the power consumption associated with the load and a desired constant power consumption for the load.

### BACKGROUND

Infrared (IR) emitters used as an IR source in Fourier transform infrared (FTIR) spectroscopy can be fabricated from sputtered depositions of metal alloys, as silicon-based microelectromechanical systems (MEMs) devices (e.g., with a nanoamorphous carbon or diamond-like carbon coating), as ribbons or coils of metal alloys, and so forth. For ribbon or coil filaments, common alloys include nickel-chromium (NiCr) alloys or iron-chromium-aluminium (FeCrAl) alloys. When heated by current flow, chromium will evaporate from NiCr alloys, forming Chromium Oxide, and aluminum will evaporate from FeCrAl alloys forming a layer of Alumina Oxide on the surface of the coil or filament. The overall long term effect of oxidation is a decrease in the net resistance of the IR Source.

### SUMMARY

Systems and techniques for supplying constant electrical power within component tolerances to a resistively changing load in an electrical circuit are described. A method includes receiving an indication of a characteristic voltage associated with a load in an electrical circuit. The method also includes receiving an indication of a characteristic current associated with the load, where the indication of the characteristic current is received as an indication of a second characteristic voltage. The method further includes determining a power consumption associated with the load based upon the indication of the characteristic voltage and the indication of the characteristic current. The method also includes adjusting at least one of a voltage or a current supplied to the load based upon the power consumption associated with the load and a desired constant power consumption for the load.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. The use of the same reference number in different instances in the description and the figures may indicate similar or identical items.

FIG. 1 is a block diagram illustrating a system configured to supply constant electrical power to a load in an electrical circuit in accordance with example embodiments of the present disclosure.

FIGS. 2A and 2B are a diagrammatic illustration of circuitry configured to supply constant electrical power to a load in an electrical circuit using a switching regulator in accordance with an example embodiment of the present disclosure.

FIG. 3 is a diagrammatic illustration of circuitry configured to supply constant electrical power to a load in an electrical circuit using a linear regulator in accordance with an example embodiment of the present disclosure.

FIG. 4 is a block diagram illustrating a system configured to supply constant electrical power to a load in an electrical circuit using analog-to-digital power conversion, a processor for implementing a feedback conversion function, and digital-to-analog power conversion in accordance with example embodiments of the present disclosure.

FIG. 5 is a block diagram illustrating a system configured to supply constant electrical power to a load in an electrical circuit in accordance with example embodiments of the present disclosure.

FIGS. 6A and 6B are a flow diagram illustrating a method for supplying constant electrical power to a load in an electrical circuit in accordance with example embodiments of the present disclosure.

### DETAILED DESCRIPTION

For some electrical circuit applications, it is desirable to energize certain electrical loads with constant electrical power (e.g., as opposed to constant voltage, constant current, unregulated power, and so forth). When “constant power” is referenced herein, it is understood that power is constant within component tolerances. For example, devices that change resistance with age, temperature, batch-to-batch variations, and so forth are typically capable of maintaining the same or similar energy output (e.g., in watts) from device to device arid/or over time when constant power is maintained to a device. Examples of such devices include, but are not necessarily limited to: silicon carbide infrared (IR) sources; thin film microelectromechanical systems (MEMs) infrared sources; wound copper coils that provide electromotive force, light, and/or heat; certain light emitting diodes (LEDs); and so on. In example embodiments, these devices are used with applications such as Fourier transform infrared (FTIR) spectroscopy. In these applications, color temperature and/or luminous efficiency may be constant when constant power is supplied to an IR source.

Systems and techniques are described that provide constant electrical power to a load, such as a resistive load. As described herein, example systems and techniques sense voltage to a load and current through the load, proportionalize the current to a second voltage, multiply the first and second voltages, and use a derived third voltage (e.g., as a loop parameter) to control electrical power supplied to the load. In embodiments of the disclosure, a control parameter is implemented as voltage feedback to a voltage regulating system or device (e.g., in implementations including, but not necessarily limited to: a reference, an error amplifier, and a comparator controlling a switch rate in a buck converter; a reference and an error amplifier in an adjustable linear regulator; an analog-to-digital (AtoD) convertor as digital input to software controlling output to a digital-to-analog (DtoA) converter; and so forth),

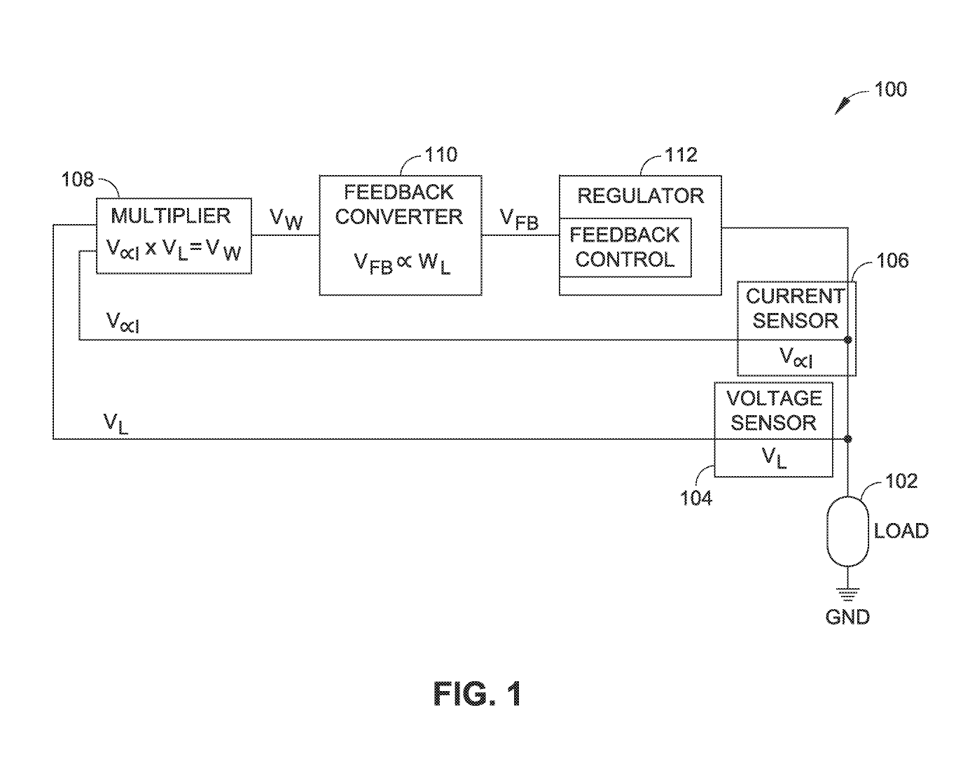

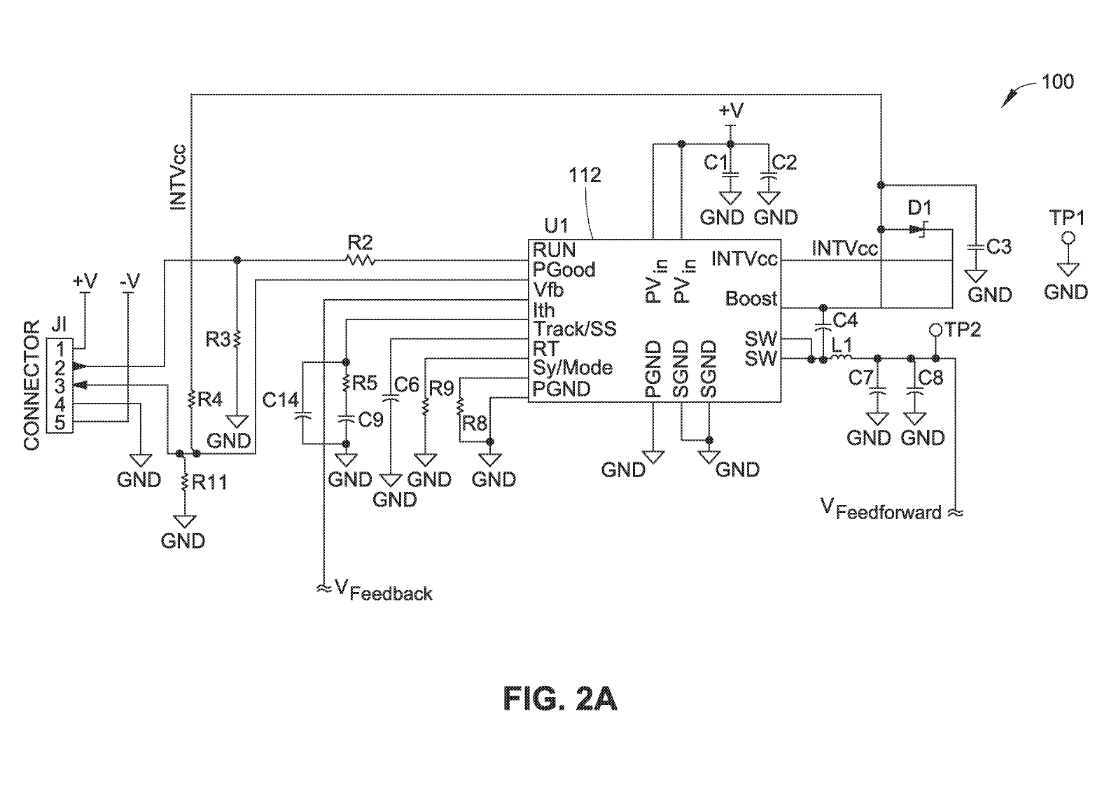

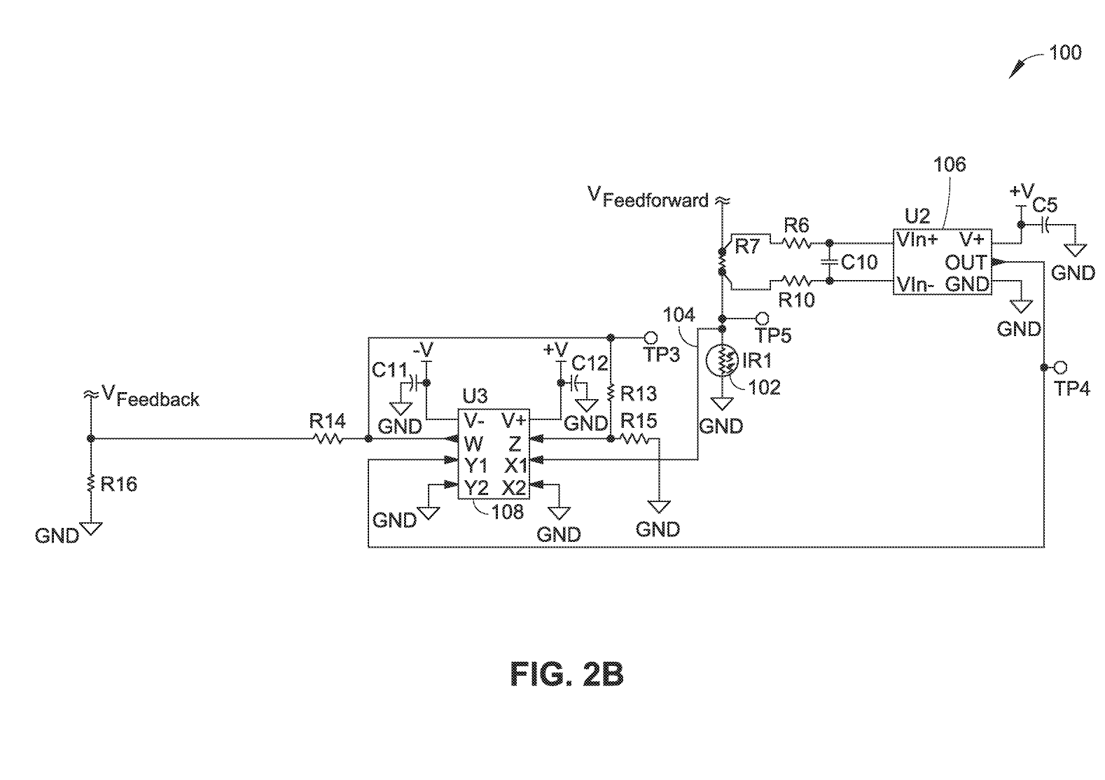

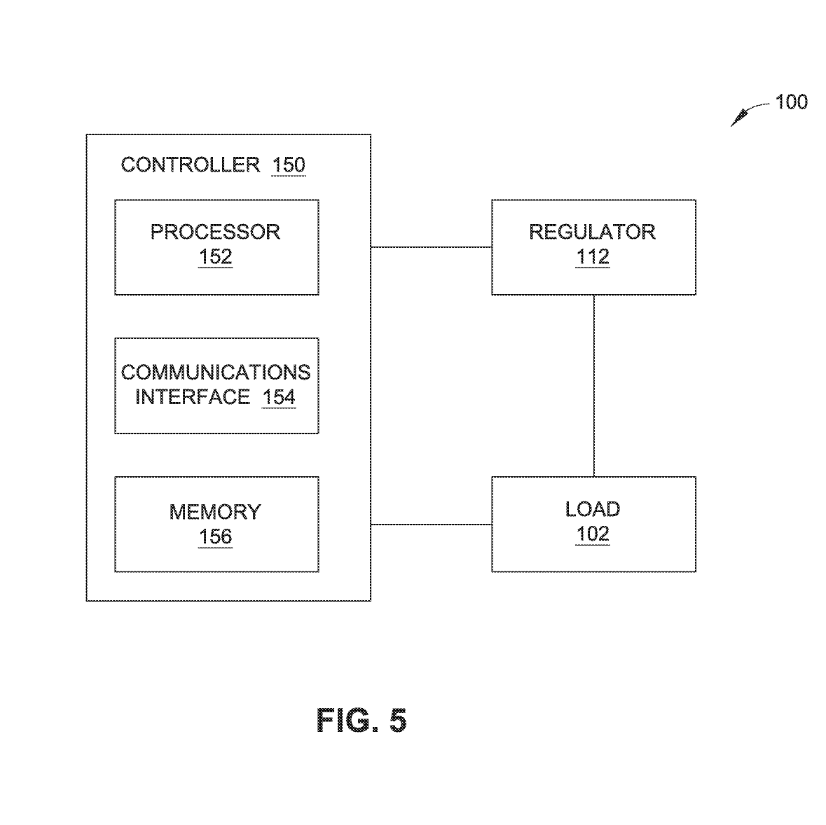

Referring generally to FIGS. 1 through 5, systems 100 configured to supply constant electrical power to a load 102 in an electrical circuit are described. The load 102 is subject to changing resistance (e.g., over time, varying from device to device, dependent upon external temperature, and so forth). In embodiments of the disclosure, the load 102 comprises a resistive load, such as a load that does not generate significant inrush current, or a load that comprises no significant inductance and/or capacitance. However, a resistive load is described by way of example only and is not meant to limit the present disclosure. In other embodiments, the load 102 comprises a load that includes inductance and/or capacitance along with resistance. The systems 100 implement a control loop, such as a feedback control loop, for controlling electrical power supplied to the load 102. In embodiments, feedback voltage derived in the control loop is a function of a first voltage E_{L} at the load 102 (V/V_{L}) and current I_{L}, through the load 102. A second voltage proportional to the current (V/A_{L}) is determined, and the first and second voltages are used to determine a feedback voltage to the regulating device (W_{L}/V). The feedback voltage can be determined by multiplying the first and second voltages, logarithmically adding the first and second voltages, and so on.

Output voltage in an electrical circuit can be varied using voltage feedback input in a system 100. A voltage V_{L} is determined at the load 102 using a voltage sensor 104. A current is determined through the load 102 using a current sensor 106. In embodiments of the disclosure, the current sensor 106 transmits an indication of the current using a voltage V_{∝I} proportional to the current (the symbol ∝ indicates “proportional”). In some embodiments, the voltage V_{∝I} is determined as a voltage drop through the current sensor 106. For example, the current sensor 106 is implemented using a sense resistor. However a sense resistor is provided by way of example only and is not meant to limit the present disclosure. In other embodiments, the current sensor 106 can be implemented using a second load connected in series with the load 102, an impedance device such as a filter coil connected in series with the load 102 (e.g., when there is sufficient voltage differential to achieve a desired resolution in compensated power with suitable amplification), and so forth.

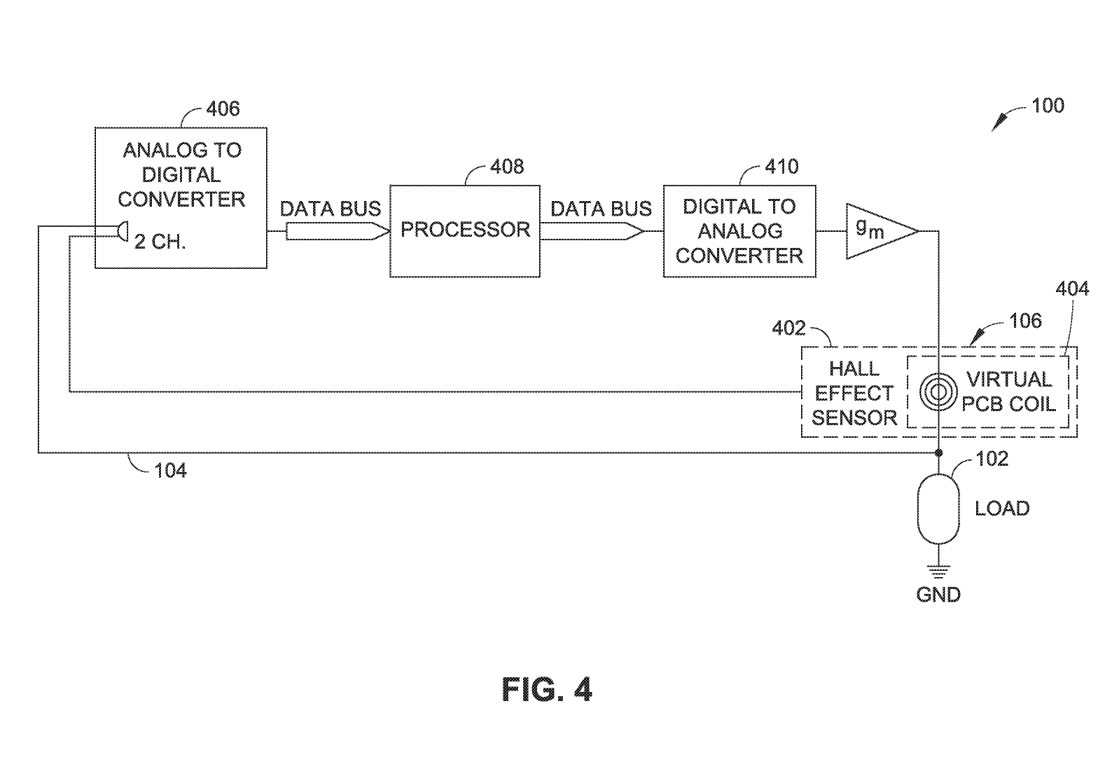

Further, the current sensor 106 can be implemented using, for instance, a device that varies its output voltage in response to a magnetic field (e.g., as shown in FIG. 4). For example, in some embodiments the current sensor 106 is implemented using one or more magneto coupled devices in proximity to a conductor supplying current to the load 102 including, but not necessarily limited to: a Hall Effect sensor 402 (e.g., with temperature compensation), a Rogowski Coil, a network of vias and traces on printed circuit board (PCB) layers surrounding a trace supplying current to the load 102, and so forth. In the configuration shown in FIG. 4, the network of vias and traces forms a virtual PCB coil 404 around the trace supplying current to the load 102 and is used to determine current through the load 102.

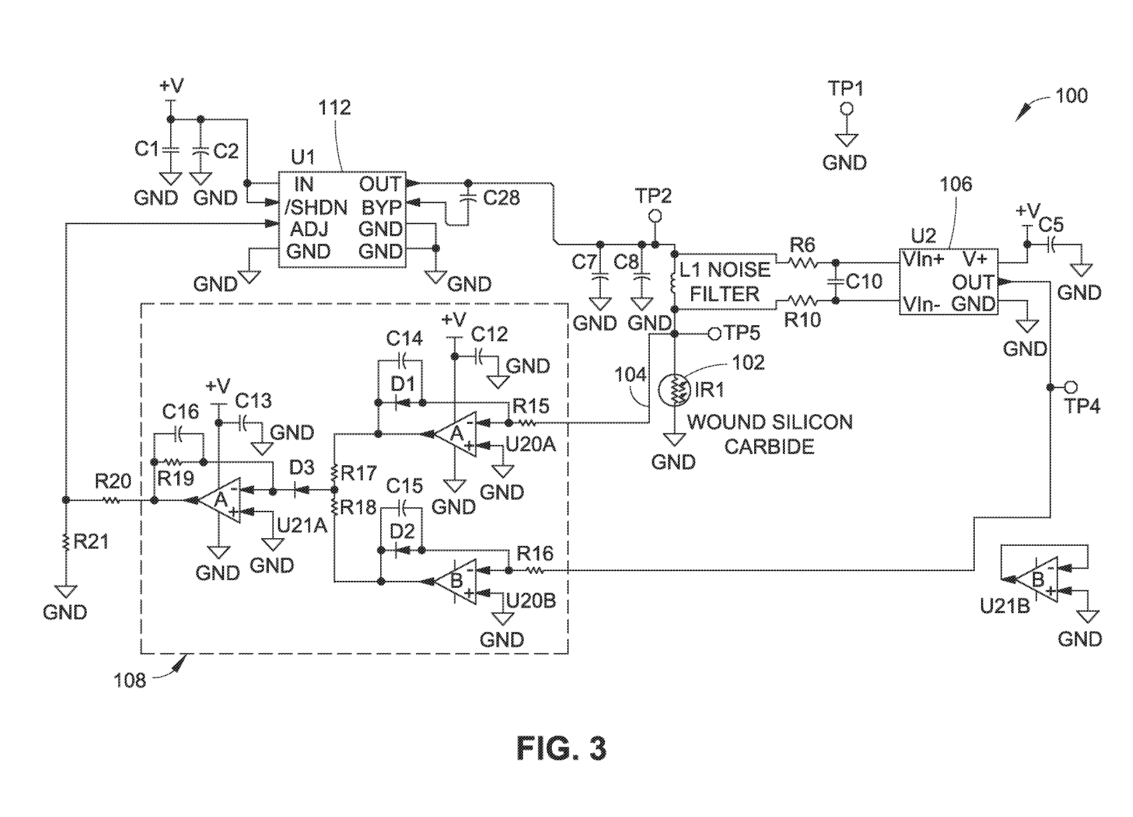

The voltage V_{L} and the voltage V_{∝I} are supplied to a multiplier 108, which determines power consumption associated with the load 102 based upon the voltage V_{L} and the voltage V_{∝I} (e.g., as a multiplied output voltage V_{W}). In some embodiments, the multiplier 108 is implemented using a translinear analog multiplier. In other embodiments, the multiplier 108 is implemented using two logarithmic operational amplifiers summed into an anti-logarithmic operational amplifier (e.g., as shown in FIG. 3). In still further embodiments, the multiplier 108 is implemented using an analog-to-digital converter (e.g., two analog-to-digital convertors, two channels of a multiplexed analog-to-digital converter 406, and so forth) input to a computing device such as a processor 408 that performs a multiplication operation and outputs the results to a digital-to-analog converter 410 (e.g., as shown in FIG. 4), and so on.

The multiplied output voltage V_{W} is supplied to a feedback converter 110, Which is configured to convert the multiplied output voltage V_{W} to a feedback voltage V_{FB}. In embodiments of the disclosure, the feedback voltage V_{FB} is directly proportional to power to the load. For example, the feedback voltage V_{FB} is a function of the following parameters: W_{L}, the desired constant power to the load; V_{int ref}, the internal voltage reference to the error amplifier and comparator of a voltage regulating system (e.g., in a hardware embodiment); V_{∝I}, the voltage proportional to the current dependent upon an amplification gain factor gₘ; and V_{L}, the voltage at the load. For example, V_{FB} can be determined as follows:

V_{FB}=V_{int ref}=((V_{∝I}/gₘ)*V_{L})/W_{L}

In some embodiments, V_{W}, the product of V_{L} and V_{∝I}, is input to a resistor divider network outputting V_{FB}. In other embodiments, one or more active devices are used to determine V_{FB}. In implementations using hardware to implement a feedback loop, the feedback loop controls V_{FB}=V_{int ref} (e.g., when an error amplifier and comparator of a voltage regulating system is implemented). However, a feedback loop implemented in hardware is provided by way of example only and is not meant to limit the present disclosure. Thus, in other implementations, the V_{FB} conversion function is implemented using firmware, software, and so forth. A regulator 112 completes the feedback loop, supplying constant power to the load 102.

In implementations, a system 100, including some or all of its components, can operate under computer control. For example, a processor can be included with or in a system 100 to control the components and functions of systems 100 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the systems 100. In the case of a software implementation, the module, functionality, or logic represents program code that performs specified tasks when executed on a processor (e.g., CPU or CPUs). The program code may be stored in one or more computer-readable memory devices (e.g., internal memory and/or one or more tangible media), and so on. The structures, functions, approaches, and techniques described herein can be implemented on a variety of commercial computing platforms having a variety of processors.

For example, the regulator 112 may be coupled with a controller 150 for controlling the electrical energy supplied to the load 102. The controller 150 may include a processor 152, a communications interface 154, and a memory 156. The processor 152 provides processing functionality for the controller 150 and may include any number of processors, micro-controllers, or other processing systems, and resident or external memory for storing data and other information accessed or generated by the controller 150. The processor 152 may execute one or more software programs, which implement techniques described herein. The processor 152 is not limited by the materials from which it is formed or the processing mechanisms employed therein, and as such, may be implemented via semiconductor(s) and/or transistors (e.g., using electronic integrated circuit (IC) components), and so forth. The communications interface 154 is operatively configured to communicate with components of systems 100, such as analog-to-digital conversion circuitry, digital-to-analog conversion circuitry, and so forth. The communications interface 154 is also communicatively coupled with the processor 152 (e.g., for communicating inputs from the analog-to-digital conversion circuitry to the processor 152). The communications interface 154 and/or the processor 152 can also be configured to communicate with a variety of different networks including, but not necessarily limited to: the Internet, a cellular telephone network, a local area network (LAN), a wide area network (WAN), a wireless network, a public telephone network, an intranet, and so on.

The memory 156 is an example of tangible computer-readable media that provides storage functionality to store various data associated with operation of the controller 150, such as software programs and/or code segments, or other data to instruct the processor 152 and possibly other components of the controller 150 to perform the steps described herein. Thus, the memory can store data, such as a program of instructions for operating a system 100 (including its components), desired constant power consumption data, and so on. Although a single memory 156 is shown, a wide variety of types and combinations of memory (e.g., tangible memory, non-transitory memory) may be employed. The memory 156 may be integral with the processor 152, may include stand-alone memory, or may be a combination of both.

The memory 156 may include, but is not necessarily limited to: removable and non-removable memory components, such as Random Access Memory (RAM), Read-Only Memory (ROM), Flash memory (e.g., a Secure Digital (SD) memory card, a mini-SD memory card, and/or a micro-SD memory card), magnetic memory, optical memory, Universal Serial Bus (USB) memory devices, hard disk memory, external memory, and other types of computer-readable storage media. In implementations, the sample detector 102 and/or memory 156 may include removable Integrated Circuit Card (ICC) memory, such as memory provided by a Subscriber Identity Module (SIM) card, a Universal Subscriber Identity Module (USIM) card, a Universal Integrated Circuit Card (UICC), and so on.

In implementations, a variety of analytical devices can make use of the structures, techniques, approaches, and so on described herein, Thus, although systems 100 are described herein, a variety of analytical instruments may make use of the described techniques, approaches, structures, and so on. These devices may be configured with limited functionality (e.g., thin devices) or with robust functionality (e.g., thick devices). Thus, a device's functionality may relate to the device's software or hardware resources, e.g., processing power, memory (e.g., data storage capability), analytical ability, and so on.

### EXAMPLE PROCESS

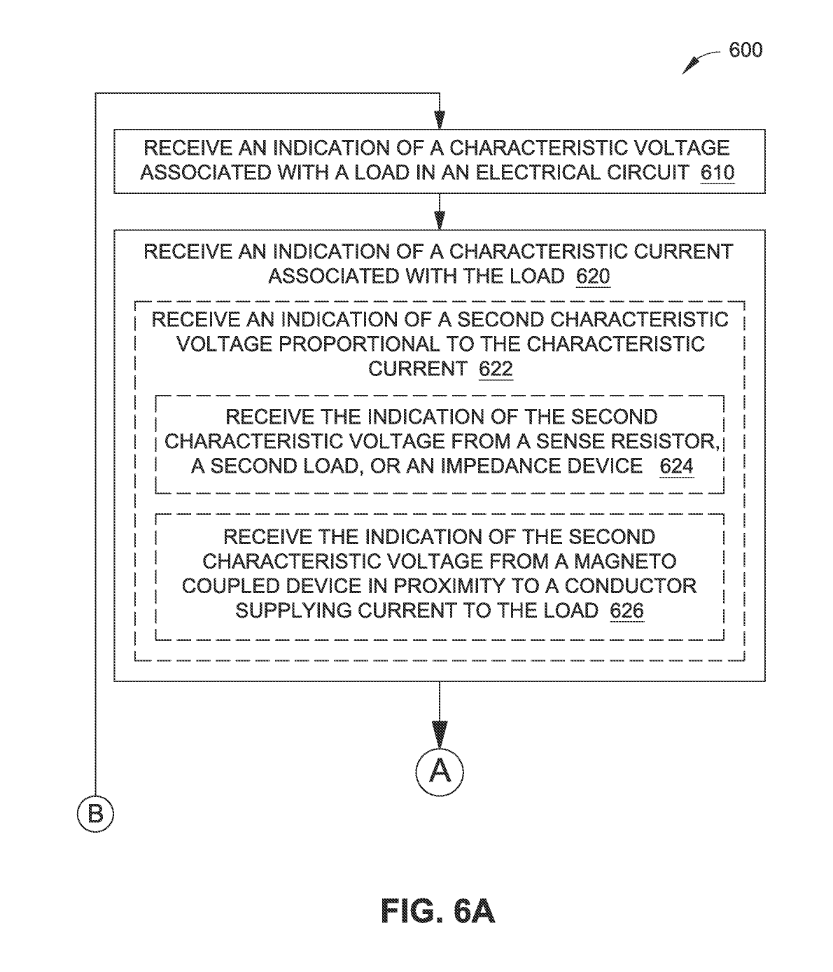

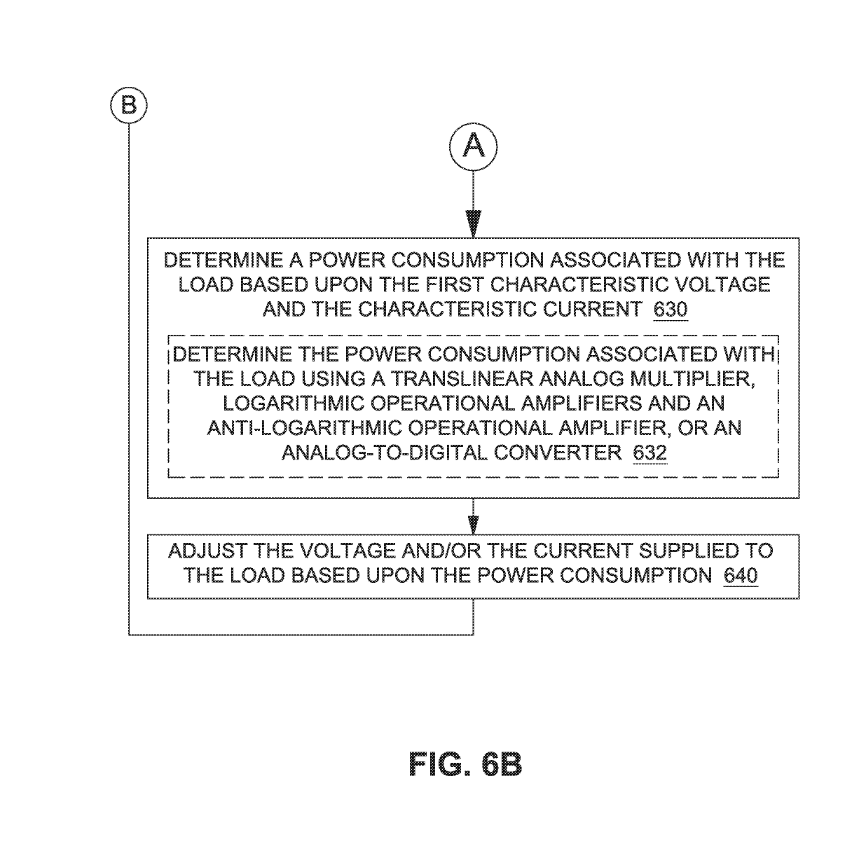

The following discussion describes example techniques for supplying constant electrical power to a load in an electrical circuit, FIGS. 6A and 6B depict a process 600, in an example implementation, for supplying constant electrical power to a load, such as the example load 102 illustrated in FIGS. 1 through 5 and described above.

An indication of a characteristic voltage associated with a load in an electrical circuit is received (610). For example, with reference to FIGS. 1 through 5, voltage sensor 104 is used to determine voltage at load 102, and an indication of the voltage is transmitted at voltage V_{L}. Then, an indication of a characteristic current associated with the load is received (620). For instance, with continuing reference to FIGS. 1 through 5, current sensor 106 is used to determine current through load 102. In some embodiments, an indication of a second characteristic voltage proportional to the characteristic current associated with the load is received (622). For example, with continuing reference to FIGS. 1 through 5, an indication of current through load 102 is transmitted at voltage V_{∝I}.

The indication of the second characteristic voltage can be received from a sense resistor, a second load, an impedance device, and so forth (Block 624). For instance, with continuing reference to FIGS. 1 through 5, voltage V_{∝I} is determined as a voltage drop through current sensor 106, where current sensor 106 is implemented using one or more of a sense resistor, a second load connected in series with the primary load, an, impedance device such as a filter coil connected in series with the primary load, and so forth. An indication of the second characteristic voltage can also be received from a magneto coupled device in proximity to a conductor supplying current to the load (Block 626). For example, with reference to FIG. 4, current sensor 106 is implemented using Hall Effect sensor 402, virtual PCB coil 404 disposed on a printed circuit board around a trace configured to supply electrical energy to the primary load, and so on.

Then, the first characteristic voltage and the characteristic current are used to determine power consumption associated with the load (Block 630). Power consumption associated with the load can be determined using a translinear analog multiplier, logarithmic operational amplifiers and an anti-logarithmic operational amplifier, an analog-to-digital converter, and so on (Block 632). For instance, with continuing reference to FIGS. 1 through 5, multiplier 108 determines power consumption for load 102 based upon voltage V_{L} and voltage V₄. Multiplier 108 is implemented using a translinear analog multiplier, two logarithmic operational amplifiers summed into an anti-logarithmic operational amplifier, an analog-to-digital converter (e.g., two analog-to-digital convertors, two channels of a multiplexed analog-to-digital converter, and so forth) input to a computing device that performs a multiplication operation and outputs the results to a digital-to-analog converter, and so on.

Next, the voltage and/or the current supplied to the load is adjusted based upon the power consumption (Block 640). For example, with continuing reference to FIGS. 1 through 5, the multiplied output voltage V_{W} is supplied to feedback converter 110, which is configured to convert multiplied output voltage V_{W} to feedback voltage directly proportional to the power associated with the load. Regulator 112 completes the feedback loop, supplying constant power to the load 102.

Although the subject matter has been described in language specific to structural features and/or methodological acts, it is to be understood that the subject matter defined in the appended claims is not necessarily limited to the specific features or acts described. Although various configurations are discussed, the apparatus, systems, subsystems, components, and so forth can be constructed in a variety of ways without departing from this disclosure. Rather, the specific features and acts are disclosed as example forms of implementing the claims.

What is claimed is:

1. A method for supplying constant electrical power to a load in an electrical circuit, the method comprising:
receiving an indication of a characteristic voltage associated with a load in an electrical circuit;
receiving an indication of a characteristic current associated with the load, the indication of the characteristic current received as an indication of a second characteristic voltage;
determining a power consumption associated with the load based upon the indication of the characteristic voltage and the indication of the characteristic current; and
adjusting at least one of a voltage or a current supplied to the load based upon the power consumption associated with the load and a desired constant power consumption for the load.

2. The method as recited in claim 1, wherein the load comprises a resistive load.

3. The method as recited in claim 1, wherein the indication of the characteristic current associated with the load is received from at least one of a sense resistor, a second load, or an impedance device.

4. The method as recited in claim 1, wherein the indication of the characteristic current associated with the load is received from a magneto coupled device in proximity to a conductor configured to supply electrical current to the load.

5. The method as recited in claim 4, wherein the magneto coupled device comprises at least one of a Hall Effect sensor, a Rogowski Coil, or a network of vias and traces disposed on a plurality of layers of a printed circuit board.

6. The method as recited in claim 1, wherein the power consumption associated with the load is determined by at least one of multiplying the indication of the characteristic voltage and the indication of the characteristic current or logarithmically adding the indication of the characteristic voltage and the indication of the characteristic current.

7. The method as recited in claim 1, wherein the power consumption associated with the load is determined using at least one of a translinear analog multiplier, a plurality of logarithmic operational amplifiers and an anti-logarithmic operational amplifier, or an analog-to-digital converter.

8. A system for supplying constant electrical power to a load in an electrical circuit, the system comprising:
a first sensor configured to provide an indication of a characteristic voltage associated with a load in an electrical circuit;
a second sensor configured to provide an indication of a characteristic current associated with the load, the indication of the characteristic current received as an indication of a second characteristic voltage;
a multiplier communicatively coupled with the first sensor and the second sensor, the multiplier configured to receive the indication of the characteristic voltage and the indication of the characteristic current and determine a power consumption associated with the load based upon the indication of the characteristic voltage and the indication of the characteristic current; and
a regulator communicatively coupled with the multiplier and operatively coupled with the load, the regulator configured to receive the power consumption associated with the load and adjust at least one of a voltage or a current supplied to the load based upon the power consumption associated with the load and a desired constant power consumption for the load.

9. The system as recited in claim 8, wherein the load comprises a resistive load.

10. The system as recited in claim 8, wherein the second sensor comprises at least one of a sense resistor, a second load, or an impedance device.

11. The system as recited in claim 8, wherein the second sensor comprises a magneto coupled device in proximity to a conductor configured to supply electrical current to the load.

12. The system as recited in claim 11, wherein the magneto coupled device comprises at least one of a Hall Effect sensor, a Rogowski Coil, or a network of vias and traces disposed on a plurality of layers of a printed circuit board.

13. The system as recited in claim 8, wherein the power consumption associated with the load is determined by at least one of multiplying the indication of the characteristic voltage and the indication of the characteristic current or logarithmically adding the indication of the characteristic voltage and the indication of the characteristic current.

14. The system as recited in claim 8, wherein the multiplier comprises at least one of a translinear analog multiplier, a plurality of logarithmic operational amplifiers and an anti-logarithmic operational amplifier, or an analog-to-digital converter.

15. A system configured to supply constant electrical power to a resistive load in an electrical circuit, the system comprising:
a first sensor configured to provide an indication of a characteristic voltage associated with a resistive load in an electrical circuit;
a second sensor configured to provide an indication of a characteristic current associated with the resistive load, the indication of the characteristic current received as an indication of a second characteristic voltage;
a processor communicatively coupled with the first sensor and the second sensor, the processor configured to receive the indication of the characteristic voltage and the indication of the characteristic current and determine a power consumption associated with the resistive load based upon the indication of the characteristic voltage and the indication of the characteristic current; and
a memory having computer executable instructions stored thereon, the computer executable instructions configured for execution by the processor to adjust at least one of a voltage or a current supplied to the resistive load based upon the power consumption associated with the resistive load and a desired constant power consumption for the resistive load.

16. The system as recited in claim 15, wherein the second sensor comprises at least one of a sense resistor, a second load, or an impedance device.

17. The system as recited in claim 15, wherein the second sensor comprises a magneto coupled device in proximity to a conductor configured to supply electrical current to the load.

18. The system as recited in claim 17, wherein the magneto coupled device comprises at least one of a Hall Effect sensor, a Rogowski Coil, or a network of vias and traces disposed on a plurality of layers of a printed circuit board.

19. The system as recited in claim 15, wherein the power consumption associated with the resistive load is determined by at least one of multiplying the indication of the characteristic voltage and the indication of the characteristic current or logarithmically adding the indication of the characteristic voltage and the indication of the characteristic current.

20. The system as recited in claim 15, wherein the power consumption associated with the resistive load is determined using at least one of a translinear analog multiplier, a plurality of logarithmic operational amplifiers and an anti-logarithmic operational amplifier, or an analog-to-digital converter.
